(19) United States
(12) Patent Application Publication
(10) Pub. No.: US 2018/0174240 A1
(43) Pub. Date: Jun. 21, 2018

(54) VISUALIZATION FOR ACCOUNT BALANCE VIEW

(71) Applicant: NASDAQ TECHNOLOGY AB, Stockholm (SE)

(72) Inventors: Ingo NEUMANN, Sydney (AU); Andreas FURCHE, Daintree (AU)

(21) Appl. No.: 15/888,848

(22) Filed: Feb. 5, 2018

Related U.S. Application Data
(63) Continuation of application No. 13/874,039, filed on Apr. 30, 2013, now abandoned.

(51) Int. Cl. G06Q 40/04

(52) U.S. Cl. CPC G06Q 40/04

(57) ABSTRACT

Systems and methods are presented for providing a visualization that is capable for displaying trade activity for one or more client accounts for a broker. The visualization includes one or more trade objects representing trades for one or more financial instruments and connectivity between one or more trade objects to show an event history for a particular trade. The visualization also provides a display for account activity including account withdrawals, deposits, and balance. The systems and method described below allow for automatic and/or manual detection of suspicious activity for a client account by virtue of information provided in the visualization.

This application is a continuation of U.S. application Ser. No. 13/874,039 filed Apr. 30, 2013, the entire contents of which are hereby incorporated by reference.

### BACKGROUND

Electronic trading systems have developed by leaps and bounds in the last several decades. Users of these systems can manually or automatically place orders with an electronic exchange where the exchange is capable of processing millions of orders every day or even millions of orders every second.

As these trading systems process large volumes of data on a daily basis, many systems provide tools for reporting trading information to users. For example, trading “tickers” provide information in an easy to understand scrolling display where different entities stock prices are shown, real-time in the “ticker.” Likewise, users can also see how much a stock price may rise/fall over a period of time on a simple 2-D graph.

Many reporting tools display relatively simple information such as the company name and current price of a stock on a stock “ticker,” for example. But, some reporting tools exist that can show general information relating to orders in the form of a graph or 3-D virtual display. However, many of these tools fail to provide an easy to follow visualization that shows orders for one or more client accounts and an event history for the orders. Furthermore, these visualizations also do not provide much information for showing suspicious activity for one or more client accounts. Thus, there is a need for an improved visualization that takes into account these drawbacks.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### SUMMARY

Systems and methods are presented for providing a visualization that is capable for displaying trade activity for one or more client accounts for a broker. The visualization includes one or more trade objects representing trades for one or more financial instruments and connectivity between one or more trade objects to show an event history for a particular trade. The visualization also provides a display for account activity including account withdrawals, deposits, and balance. The systems and method described below allow for automatic and/or manual detection of suspicious activity for a client account by virtue of information provided in the visualization.

A method implemented in an information processing apparatus having one or more processors and for displaying a visualization for activity in a client account includes receiving trade data for one or more client accounts from at least one broker device, the trade data including one or more trade messages involving the one or more client accounts and the one or more trade messages including one or more financial instruments, generating a graph, configured to be displayed on a display device, with a time scale displayed along a first axis of the graph and a trade value scale displayed along a second axis of the graph, and populating, via the one or more processors, the generated graph with one or more trade objects representing the one or more trades, the one or more trade objects providing an event view of trading activity for the one or more client accounts.

Another aspect of the technology relates to a non-transitory computer-readable storage medium having computer readable code embodied for displaying a visualization for activity in a client account which, when executed by a computer having one or more processors, performs functionality comprising receiving trade data for one or more client accounts from at least one broker device, the trade data including one or more trade messages involving the one or more client accounts and the one or more trade messages including one or more financial instruments, generating a graph, configured to be displayed on a display device, with a time scale displayed along a first axis of the graph and a trade value scale displayed along a second axis of the graph, and populating, via the one or more processors, the generated graph with one or more trade objects representing the one or more trades, the one or more trade objects providing an event view of trading activity for the one or more client accounts.

Another aspect of the technology relates to an information processing apparatus including a memory configured to store trade data for one or more client accounts, and one or more processors coupled to the memory and configured to display a visualization for activity in a client account. The one or more processors further configured to perform functionality comprising accessing one or more client accounts and retrieving transaction data corresponding to one or more financial transactions involving the respective client account, generating a graph with a time scale displayed along a first axis and a value scale displayed along a second axis, the graph including one or more points corresponding to the one or more financial transactions, and creating one or more links between the one or more points, the links capable of showing an event history for the one or more financial transactions.

An information processing system including one or more broker devices that are configured to provide financial transaction data to the information processing apparatus of the preceding paragraph.

In a non-limiting, example implementation the trade value scale having one or more value components contains a price and a volume of the one or more trades in the trade data.

In another non-limiting, example implementation the one or more trade objects are configured to be displayed based on an absolute value of the trade.

In yet another non-limiting, example implementation the one or more trade objects are configured to be displayed by aligning the one or more trades relative to an account balance for the one or more clients.

In another non-limiting, example implementation an overlay window is generated when one of the one or more trade objects are selected, the overlay window providing detailed information for the selected trade object.

In yet another non-limiting, example implementation the one or more objects are configured to be displayed as one or more shapes corresponding to at least one of an entered trade, an amended trade, and/or a deleted trade.

In another non-limiting, example implementation the one or more trade objects are capable of showing changes that exceed a predetermined threshold in an account balance for a client thereby indicating potential fraudulent activity associated with the account.

In yet another non-limiting, example implementation the one or more trade objects are analyzed and an indication, configured to be displayed on the display device, of possible fraudulent activity is generated when a result of the analysis exceeds a predetermined threshold.

### BRIEF DESCRIPTION OF THE DRAWINGS

FIG. 1 is a block diagram of an electronic exchange system interacting with a broker device;

FIG. 2 is a block diagram showing a broker device processing one or more trades with the electronic exchange system;

FIG. 3(a) is an example diagram of a visualization for displaying trading activity for one or more client accounts in one embodiment;

FIG. 3(b) is an example diagram of a visualization for displaying trading activity for one or more client accounts in another embodiment

FIG. 4 is an example flowchart describing a process for generating a visualization for displaying trading activity for one or more client accounts; and

FIG. 5 is an example flowchart describing a process for warning users of suspicious account/trading activity using the visualization for displaying trading activity.

### DETAILED DESCRIPTION

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions. Although databases may be depicted as tables below, other formats (including relational databases, object-based models, and/or distributed databases) may be used to store and manipulate data.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the technology, and does not imply that the illustrated process is preferred.

Various forms of computer readable media/transmissions may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards or protocols, such as Ethernet (or IEEE 802.3), SAP, ATP, Bluetooth, and TCP/IP, TDMA, CDMA, 3G, etc.; and/or (iv) encrypted to ensure privacy or prevent fraud in any of a variety of ways well known in the art.

The technology described below is directed to a visualisation that allows observers to see how the account balance of a client develops over time. This can be useful for surveillance because, at a glance, it helps to identify trading patterns which are executed to launder money which would otherwise be non-obvious when viewing standard spread graphs, for example. By using such visualizations, the value of trades can be aligned to the account graph in order to visualise how the client trades have affected the account balance.

Current single market visualisations show all trades of a single equity on a price vs. time graph. The visualization described in this application, however, provides the value of trades and the account balance on an axis of the graph.

Existing visualizations also can only highlight client trades for a single instrument at a time. Likewise, these visualizations are more focused on a per instrument view and do not provide an event based view of all trading activities for a particular client account. The visualization described herein is capable of showing all trades for any instrument traded by a client at any time.

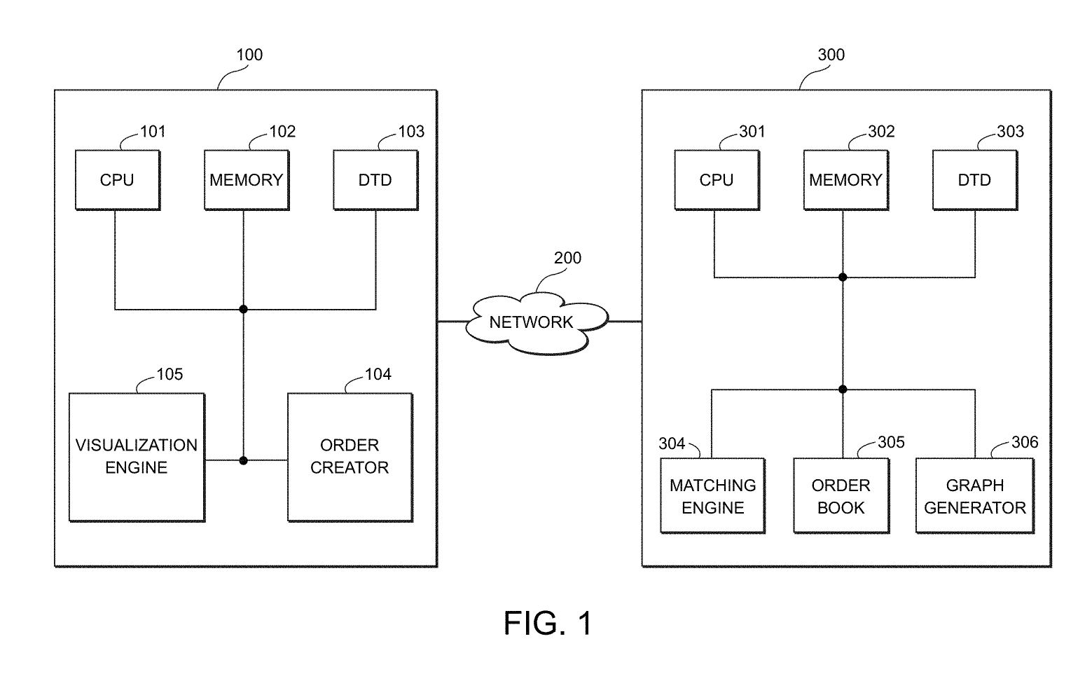

FIG. 1 is an example diagram showing an electronic exchange system 300 communicating with at least one broker device 100 via a network 200. The broker system 100 can be implemented with and/or used via a personal computer, a PDA device, a cell phone, a server computer, or any other system/device for conducting the electronic exchange described herein. It should also be appreciate that the broker system 100 is not limited to a broker but can be any individual and/or business conducting electronic exchange of financial instruments. It should also be appreciated that the electronic exchange 300 communicates with a plurality of broker systems 100 to match orders.

The broker system 100 includes a central processing unit (CPU) 101, a memory 102, and a data transmission device 103. The data transmission device (DTD) 103 can be, for example, a network interface device that can connect the broker system 100 to the network 200. The connection can be wired, optical, or wireless and can connect over a Wi-Fi network, the Internet, or a cellular data service, for example. The data transmission device 103 can also be an input/output device that allows the broker system 100 to place the data on a computer-readable storage medium. It should be appreciated that the data transmission device 103 is capable of sending and receiving data (i.e. a transceiver).

The broker system 100 can be used for conducting exchange of financial instruments with the electronic exchange system 300. The broker system 100 can take an order from a user and then generate an order message using the order creator 104. Upon finishing the order, the order creator 104 transmits the order over the network 200 using the data transmission device 103. The electronic exchange system 300 then receives the order for processing. The broker device 100 is also configured to have a visualization engine 105 that is capable of generating and displaying a user interface and visualization for trade activity. The visualization can be created by data received from the electronic exchange system 300 and/or one or more broker devices 100. Likewise, the data for generating the visualization can be generated at the exchange system 300 or can be generated by the broker device 100.

The electronic exchange system 300 includes a CPU 301, a memory 302, and a data transmission device 303. In a preferred example embodiment, the electronic exchange system 300 may include multiple processors and/or memories and may be designed for fail-safe redundancy. The data transmission device (DTD) 303 can be, for example, a network interface device that can connect the exchange 300 to the network 200. It should be appreciated that the data transmission device 303 is capable of sending and receiving data (i.e. a transceiver).

The electronic exchange system 300 also has a matching engine 304, implemented using one or more processors, for matching orders received from one or more broker devices 100 and an order book memory 305 for storing orders. It should be appreciated that the order book 305 can exist in the memory 302 of the electronic exchange system 300. The electronic exchange system 300 is also configured to have a graph generator 306 for generating graph data for displaying the visualization. The graph generator 306 is capable of compiling data so that one or more broker devices 100 may render the visualization directly from the compiled data. Likewise, the graph generator 306 is also capable of generating display data that can be transmitted to one or more broker devices 100 where the broker devices 100 can display the graph via one or more display devices associated with the broker device 100.

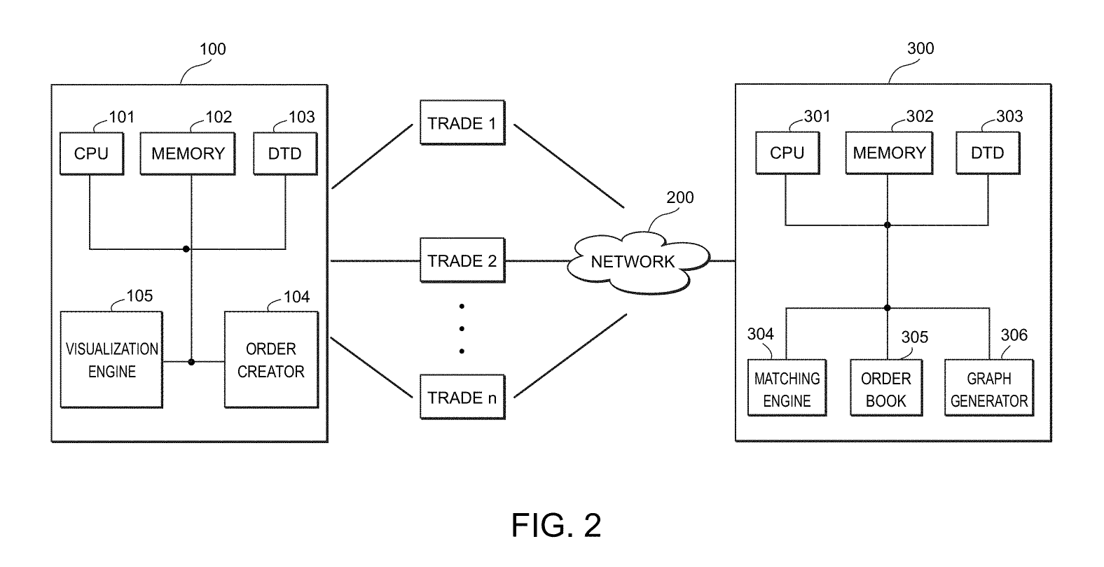

FIG. 2 shows an example block diagram showing a broker device 100 processing one or more trades with the electronic exchange system 300. In the example shown in FIG. 2, the broker device 100 communicates trade/order messages for orders 1-n to the electronic exchange system 300 via the network 200. As explained above, the orders can be generated via a user interface at the broker device 100 or can be created automatically by the device 100 and sent as electronic order data messages using the order creator 104.

The electronic exchange system 300 is capable of matching, via the matching engine 304, the orders 1-n with orders in the order book 305. The electronic exchange system 300 is also capable for storing history data for the orders in the memory 302. By having history data for the orders, the graph generator 306 is capable of generating data for rendering a visualization that displays trading activity for one or more client accounts. The generated graph data can then be transmitted to one or more broker devices 100 where the visualization engine 105 on the broker device 100 is capable of generating the displayed visualization. In an example embodiment, the broker device 100 will have an input interface for a user to display the visualization and interact with the visualization.

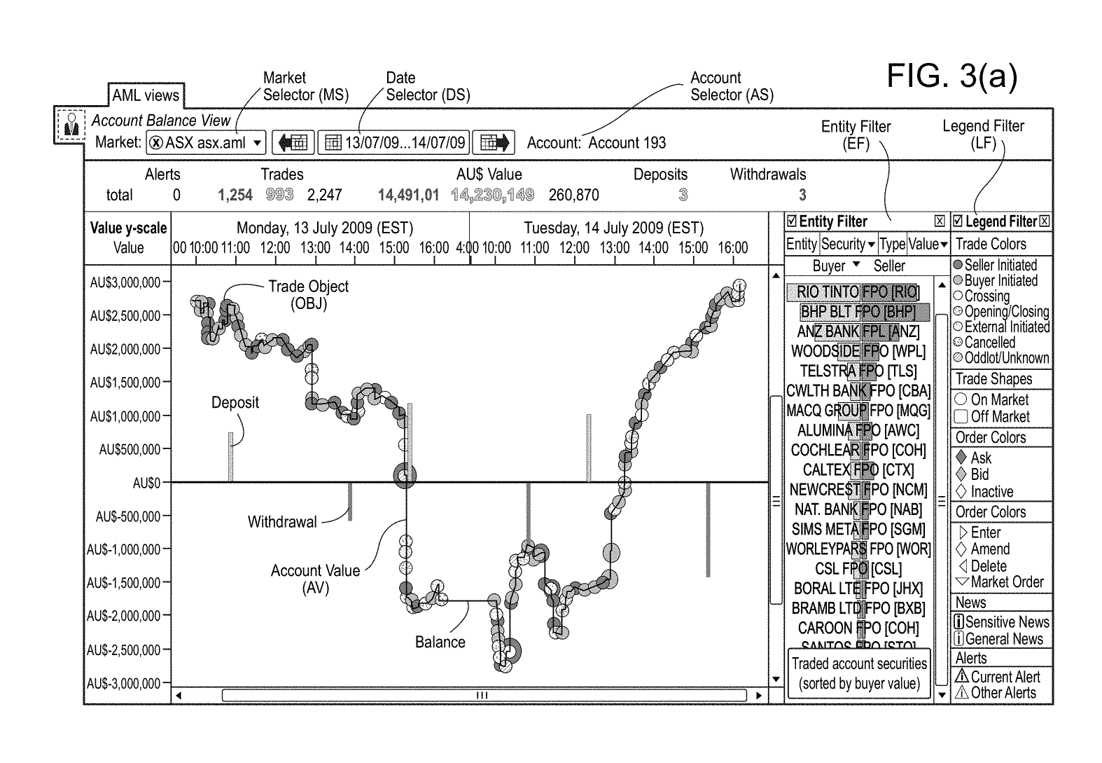

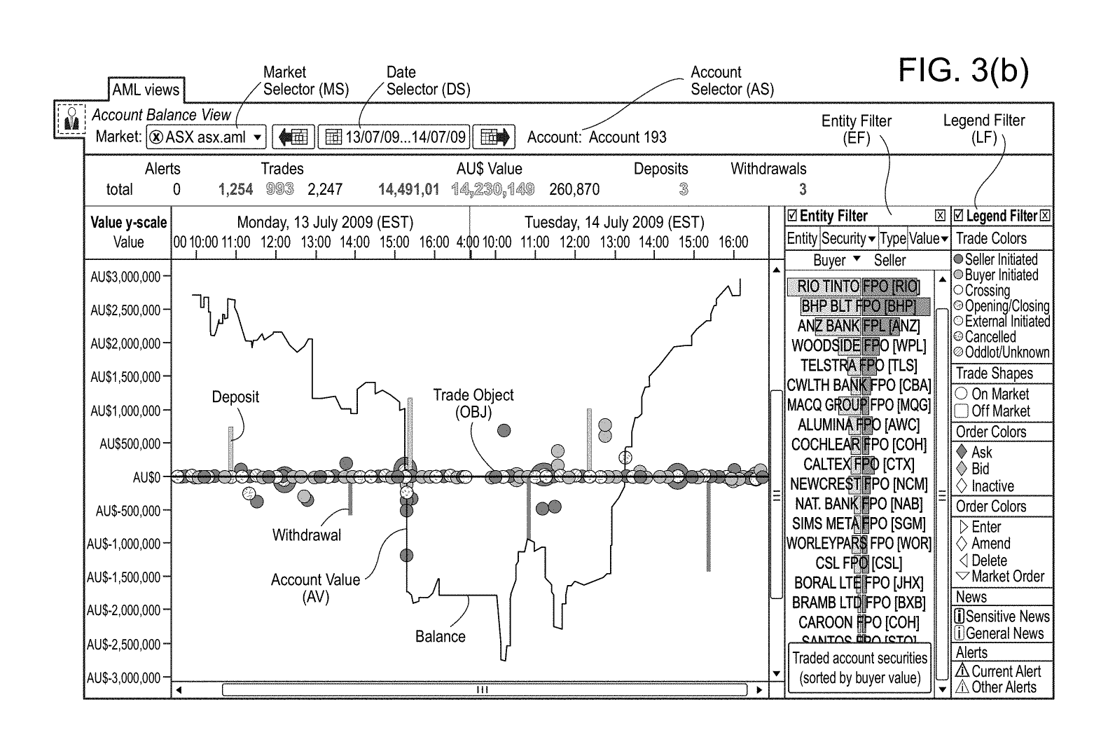

FIG. 3(a) is an example diagram of a visualization for displaying trading activity for one or more client accounts. In the embodiment shown in FIG. 3(a), the visualization is presented in an “aligned mode” where trades can be plotted relative to the account value AV of an account. That is, the diagram of the visualization in FIG. 3(a) shows the trades plotted along the line representing the account value AV as they are shown relative (e.g., aligned) with the account value.

Although not limited to the diagram shown in FIG. 3(a), the visualization can have a time scale along a first axis (e.g., the X-axis) and a value scale along a second axis (e.g., the Y-axis). It should be appreciated that the value along the value scale is for a price and volume of a particular trade. For example, the value can indicate an order/trade for 100 shares of IBM stock at $52.55 per share. Thus, the value component is capable of showing both the price and volume as one value.

In the visualization shown in FIG. 3(a), all trades of an account are plotted (e.g., as circles) as trade objects OBJ at the time they occurred along the X-axis. The size of a trade object OBJ can be an indicator of the trade volume where the y-position for each trade can depend upon a user selected plotting mode, for example. As explained above, the example visualization in FIG. 3(a) shows an “Align to Balance” plotting mode where trades are plotted aligned relative to the account balance. Such a plotting mode can allow for easy identification as to why the account balance of a client has developed over time. For example, the plotting mode makes it easier to spot trades that have caused high jumps in the account balance and it is also easier to see how a lot of small trades affect the account balance.

FIG. 3(b) is another example diagram of a visualization for displaying trading activity for one or more client accounts. FIG. 3(b) shows another plotting mode for the visualization of the present technology referred to as an “Absolute Value” plotting mode (or rather, a “not aligned” mode). In the “Absolute Value” plotting mode, all trades are plotted at their absolute value. This plotting mode can be useful when identifying trades with high values. For example, in the “Absolute Value” plotting mode, the trade are plotted by their value (e.g., price*volume) along a Y-axis where the Account Value AV path is displayed over time. In the example shown in FIG. 3(b), the order objects OBJ are displayed closer in a cluster along the Y-axis as opposed to FIG. 3(a) where the order objects OBJ are displayed along (e.g., relative) the account value AV line.

Regardless of the plotting mode, graphical indicators showing account deposits, withdrawals, and account balances are also drawn in the visualization. These indicators are useful to see how the actual account balance is affected by money transfers. In the example shown in FIGS. 3(a) and 3(b), the deposit indicator can be shown with a green line, the withdrawal indicator can be shown with a red line, and the balance indicator can be shown with a blue line. Of course, any variation of colors may be used and are in no way limited to this example.

FIGS. 3(a) and 3(b) also show a market selector MS, a date selector DS, and an account selector AS. The market selector MS is configured to allow selection of a market file for a particular client account. The date selector DS allows for selecting a specific day of market activity. The data selector DS can also be configured to allow selection of a range of dates for market activity. The account selector AS allows for selection of a specific client account. Thus, the visualization can display activity for a client account for a broker over a given time period.

The visualization shown in the diagrams of FIGS. 3(a) and 3(b) are also capable of including an entity filter EF for filtering one or more types of a variety of entities. In the example shown in FIGS. 3(a) and 3(b), the entity filter is showing trade data for a securities entity with the value for each security. The Entity Filter EF, which allows selection of trading entities, also works as per an Equity visualisation, such that trades (and orders) by a particular Security/Trader/House can be identified by applying a colour mask. Of course, the entity and filter type are not limited to securities and a value amount and can be a variety of different options. For example, an entity type could be all possible trading entities such as an exchange member, a broker firm, an actual broker, or a market maker. Likewise, a filter type could be a financial instrument type (e.g., a trade-able asset of any kind) such as equity class types as stocks/shares, stock options, equity futures or other so called exotic instruments. There are also debt type class instruments such as bonds/loans, bond futures, options on bond futures, and/or interest rate swaps. Likewise, there may also be ETFs, and foreign exchange (FX) type of instruments such as spot FX, currency futures and various options of FX products.

The visualization shown in FIGS. 3(a) and 3(b) can also include a legend filter LF for filtering one or more displayed trade objects OBJ in the visualization. The legend filter LF can filter trade types for trades in a client account. The trade types can include, but are not limited to, seller initiated trades, buyer initiated trades, crossing trades, opening/closing of market activity, external initiated trades, canceled trades/orders, and/or even trades with unknown origin. It should be appreciated that a “crossing trade” can be when buy/sell sides are “crossed” (i.e., when the bid price of a security exceeds the ask price). Also, trades with “unknown origin” can refer to trades/orders that are originating from an unregistered user (e.g., via “naked access”). For example, “naked access” can involve brokers giving high-frequency traders unfettered access to public markets. “Naked access” allows high-speed traders and others to buy/sell stocks on exchanges using a broker's system without requiring them to filter through the broker's system or undergo any pre-trade checks.

Each trade type can have a color associated with it so that when the trade object OBJ is generated in the visualization, a user will know whether the object OBJ refers to a seller initiated trade versus a buyer initiated trade, for example. The visualization can also include one or more trade shapes for “on market” or “off market” trades, for example, and one or more order colors for a particular type of order (e.g., ask, bid, inactive). The legend filter LF can also include multiple order shapes for different statuses related to an order (e.g., entered, amended, deleted, and/or market order). The legend filter LF is also capable of showing news related information (e.g., sensitive news, general news) and various alerts (e.g., current alerts, other alerts).

Although not shown in FIGS. 3(a) and 3(b), when a trade object OBJ is selected, via a user interface for example, further information of the trade is provided. More specifically, an overlay window is generated providing further details of the trade data represented by the selected trade object OBJ.

As discussed above, the example visualization shown in FIGS. 3(a) and 3(b) are useful for showing account activity for a client. With this visualization one can automatically or manually detect indications of suspicious activity for a particular client. For example, a large swing in trading activity for a specific stock right before a major announcement (that would affect the stock price) may indicate insider trading. Likewise, unusual deposits/withdrawals may also indicate suspicious activity for a particular client. Thresholds can be set/determined for automatically providing warnings to an entity when the so-called suspicious activity occurs.

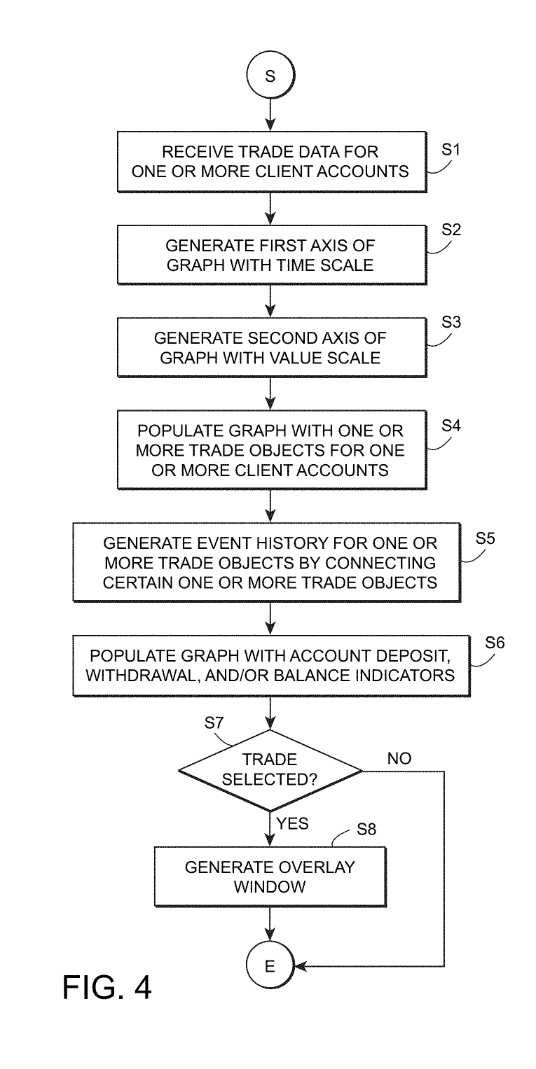

FIG. 4 is an example flowchart describing a process for generating a visualization for displaying trading activity for one or more client accounts. The process can be implemented by the one or more broker devices 100 and/or the electronic exchange system 300. The process begins by receiving trade data for one or more client accounts from one or more broker devices 100 (S1). The trade data can be compiled and then used to generate a graph for displaying the visualization. In generating the graph, a first axis of the graph with a time scale is generated (S2) along with a second axis of the graph with a value scale (S3).

Using the received trade data, the graph can be populated with one or more trade objects for one or more client accounts. As discussed above and as shown by example in FIGS. 3(a) and 3(b), the trade objects can be represented as circles where a size of the circle can represent the value of the trade. The trade objects can also be connected, via a drawn line for example, to generate an event history for the one or more trade objects (S5). As an example, consider an order to buy 100 shares of IBM stock at $50 per share. A first trade object can show the initial buy order by generating a green circle representing the particular order. Various orders for selling shares of IBM stock for $50 per share may then be processed against the buy order. For example, four orders to sell 25 shares each of IBM stock at $50 per share may automatically match at the exchange 300 with the order to buy 100 shares of IBM stock. Thus, the visualization may show the trades for the four orders to sell 25 shares that match against the buy order to buy 100 shares as red circles on the visualization. By connecting these circles, an event history can be seen showing the event life cycle for a particular order. That is, one can easily see the progression of matching for a buy order of 100 shares of stock with 4 sell orders for 25 shares of stock each, simply by connecting the drawn circles (representing the 5 buy/sell objects) in the visualization.

In addition to generating order objects with an event history in the visualization, the graph can be populated with account deposit, withdrawal, and/or balance indicators (S6). As can be seen in FIGS. 3(a) and 3(b), the account deposit, withdrawal, and balance indicators can be shown as lines indicating how much has been moved in the account or how much is left in the account. As explained above, the event history and the deposit, withdrawal, and balance indicators can help identify suspicious/fraudulent activity occurring in the account.

Using an interface for input on the graph, the system can determine if a trade object is selected for viewing further detail (S7). If so, an overlay window can be generated and displayed (S8) providing further details related to the trade object. As explained above, such a visualization allows for easier view of client activity and easier detection of any suspicious activity.

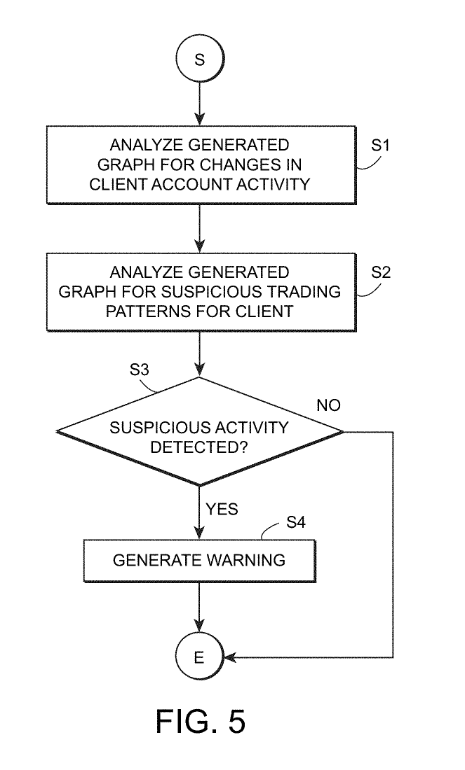

FIG. 5 is an example flowchart describing a process for warning users of suspicious account/trading activity using the visualization for displaying trading activity. The process can be implemented by one or more of the broker devices 100 or can be implemented by the exchange 300. Using the visualization as created by the processes provided in FIG. 4, and as shown by example in FIGS. 3(a) and 3(b), the system can analyze the generated graph for changes in client account activity (S1). The system can also analyze the generated graph for suspicious trading patterns for a particular client (S2). As discussed above, for example, the system can be configured to detect changes in account activity beyond a particular threshold. For example, any withdrawal/deposit over $500,000 USD may cause the system to raise a “flag” indicating that certain activity has occurred which may require further investigation. Likewise, certain trades that exceed a particular value or trades that occur for a stock just prior to a major announcement for the company selling the stock may also be “flagged.”

If the suspicious activity is detected by exceeding the threshold values (S3) a warning can be generated (S4) indicating that the account/client may require further investigation. For example, an overlay window may be activated indicating that the particular activity may require further review. Likewise, the visualization may employ an alert on the graphics themselves indicating that the activity is suspicious. Of course, the technology is not limited to these examples and envisions many methods for warning suspicious activity.

While the technology has been described in connection with what is presently considered to be the most practical and preferred embodiment, it is to be understood that the technology is not to be limited to the disclosed embodiment, but on the contrary, is intended to cover various modifications and equivalent arrangements included within the spirit and scope of the appended claims.

1-20. (canceled)

21. A system configured to generate data for a visualization, comprising:
a processor;
a memory; and
a transceiver,
wherein the processor, the memory, and the transceiver are configured to at least:
receive trade data from at least one device, including one or more electronic trade messages containing information for one or more trades for an account;
store the trade data in the memory;
determine a display mode for generating a visualization that includes at least a graph configured to be displayed on a display device;
generate the graph based on the determined display mode, the graph having a time axis along a first axis and a value scale axis along a second axis;
populate, using the trade data in the one or more electronic trade messages, the generated graph with one or more trade objects, wherein
each of the trade objects corresponding to a respective trade from the one or more trades,
for each of the trade objects, the trade object graphically indicates a type for the trade to which the trade object corresponds, and
the one or more trade objects are plotted along the first axis and the second axis in the graph to indicate a change in account value over time;
detect changes in the account value, for the account associated with the one or more trade objects, to determine if the account value has exceed a threshold value for a given period of time;
generate an alert associated with the account when the account value has exceeded the threshold value for the given period of time; and
render the generated graph into the visualization for display on the display device, the generated alert displayed with the rendered graph when the account value has exceeded the threshold value for the given period of time.

22. The system of claim 21, wherein the value scale axis having one or more value components containing a price and a volume of the one or more trades in the trade data.

23. The system of claim 21, wherein the display mode includes at least an align to balance plotting mode and an absolute value plotting mode.

24. The system of claim 21, wherein the visualization is configured to align a value of trades on an account graph in order to visualize how trades have affected an account balance.

25. The system of claim 21, wherein the one or more trade objects are configured to be displayed as one or more shapes corresponding to at least one of an entered trade, an amended trade, or a deleted trade.

26. The system of claim 21, wherein the visualization further includes additional graphical indicators representative of, at least, a withdrawal amount, a deposit amount, and an account balance amount.

27. The system of claim 21, wherein the visualization further includes at least one path, indicative of the account value, drawn on the graph showing a change in the account value over time.

28. A method for generating data for a visualization, comprising:
in an information processing system having at least a memory, a transceiver, and a processor:
receiving trade data from at least one device, including one or more electronic trade messages containing information for one or more trades for an account;
storing the trade data in the memory;
determining a display mode for generating a visualization that includes at least a graph configured to be displayed on a display device;
generating the graph based on the determined display mode, the graph having a time axis along a first axis and a value scale axis along a second axis;
populating, using the trade data in the one or more electronic trade messages, the generated graph with one or more trade objects, wherein
each of the trade objects corresponding to a respective trade from the one or more trades,
for each of the trade objects, the trade object graphically indicates a type for the trade to which the trade object corresponds, and
the one or more trade objects are plotted along the first axis and the second axis in the graph to indicate a change in account value over time;
detecting changes in the account value, for the account associated with the one or more trade objects, to determine if the account value has exceed a threshold value for a given period of time;
generating an alert associated with the account when the account value has exceeded the threshold value for the given period of time; and
rendering the generated graph into the visualization for display on the display device, the generated alert displayed with the rendered graph when the account value has exceeded the threshold value for the given period of time.

29. The method of claim 28, wherein the value scale axis having one or more value components containing a price and a volume of the one or more trades in the trade data.

30. The method of claim 28, wherein the display mode includes at least an align to balance plotting mode and an absolute value plotting mode.

31. The method of claim 28, wherein the visualization is configured to align a value of trades on an account graph in order to visualize how trades have affected an account balance.

32. The method of claim 28, wherein the one or more trade objects are configured to be displayed as one or more shapes corresponding to at least one of an entered trade, an amended trade, or a deleted trade.

33. The method of claim 28, wherein the visualization further includes additional graphical indicators representative of, at least, a withdrawal amount, a deposit amount, and an account balance amount.

34. The method of claim 28, wherein the visualization further includes at least one path, indicative of the account value, drawn on the graph showing a change in the account value over time.

35. A system, comprising:
a server having at least a processor, a memory, and a transceiver, the processor, memory, and transceiver acting in cooperation with each other and configured to cause the server to:
receive trade data from at least one device, including one or more electronic trade messages containing information for one or more trades for an account;
store the trade data in the memory;
determine a display mode for generating a visualization that includes at least a graph configured to be displayed on a display device; and
generate data for displaying the visualization based on the determined display mode, and
at least one client device having at least a processor, a memory, and a transceiver, the processor, memory, and transceiver acting in cooperation with each other and configured to cause the at least one client device to:
receive the data for displaying the visualization;
generate the graph using the received data, the graph having a time axis along a first axis and a value scale axis along a second axis;
populate the generated graph with one or more trade objects, wherein
each of the trade objects corresponding to a respective trade from the one or more trades,
for each of the trade objects, the trade object graphically indicates a type for the trade to which the trade object corresponds, and
the one or more trade objects are plotted along the first axis and the second axis in the graph to indicate a change in account value over time;
render the generated graph into the visualization for display on a display device.

36. The system of claim 35, wherein the processor, memory, and transceiver are further configured to cause the server to:
detect changes in the account value, for the account associated with the one or more trade objects, to determine if the account value has exceed a threshold value for a given period of time; and
generate an alert associated with the account when the account value has exceeded the threshold value for the given period of time.

37. The system of claim 36, wherein the generated alert displayed with the rendered graph when the account value has exceeded the threshold value for the given period of time.

38. The system of claim 35, wherein the display mode includes at least an align to balance plotting mode and an absolute value plotting mode.

39. The system of claim 35, wherein the visualization is configured to align a value of trades on an account graph in order to visualize how trades have affected an account balance.

40. The system of claim 35, wherein the visualization further includes at least one path, indicative of the account value, drawn on the graph showing a change in the account value over time.
